(19) United States
(12) Patent Application Publication
(10) Pub. No.: US 2024/0215555 A1
(43) Pub. Date: Jul. 4, 2024

(54) DEVICE FOR HOLDING A CORAL CUTTING, AND SUPPORT STRUCTURE

(71) Applicant: CORAIL ARTEFACT HOLDING, Paris (FR)

(72) Inventor: Jérémy GOBE, Paris (FR)

(21) Appl. No.: 18/556,965

(22) PCT Filed: Apr. 25, 2022
(86) PCT No.: PCT/EP2022/060808

§ 371 Date: Oct. 24, 2023

(30) Foreign Application Priority Data
Apr. 26, 2021 (FR) FR2104303

(51) Int. Cl. A01K 63/00

(52) U.S. Cl. CPC A01K 63/006

(57) ABSTRACT

The present invention relates to a device for holding a coral cutting, the device comprising: a first hollow tubular element extending along a longitudinal axis and comprising a distal end, a proximal end, an inner face and an outer face, and a second element arranged coaxially at the proximal end of the first element and comprising a flared part defining a planar surface comprising a plane diverging circumferentially around the longitudinal axis of the first element, and the device having a textured surface.

### TECHNICAL FIELD

The invention relates to devices for holding fragments or cuttings, and to structures of support for such devices, for the cultivation and growth of aquatic animals, in particular corals. These devices and structures may be used in aquariums but also in marine environments to allow the growth of corals from cuttings.

The present invention also relates to a method for manufacturing these devices and support structures as well as to the use of biodegradable polymers to manufacture these devices and support structures.

### PRIOR ART

Corals are a diverse group of anemone-like animals that live in marine environments. Corals include soft corals, hard corals, sponges, sea fans, etc. Hard coral, an animal of the Cnidaria family, is made up of several individuals, or polyps, which share a common skeleton, essentially composed of calcium carbonate. Together, these polyps and their skeleton form a colony.

Many types of corals may be grown asexually by propagation from fragments or cuttings. For example, a piece of living coral may be broken into smaller pieces or fragments. A fragment is then attached to a base or a support. After cutting off a fragment of a colony, the living tissue of this fragment, or cutting, made up of polyps, will heal and resume its development, producing a skeleton and new polyps, thus creating a new colony. Taking coral cuttings allows, in particular, the implantation of cuttings on reefs to help natural regeneration thereof, to avoid taking corals from the natural environment to be sold to aquarists, the development of corals in the laboratory for scientific studies and public display, and the collection of endangered species.

It is important to attach the coral fragment to a base or a support during the early stages of propagation so that the coral can develop properly. If the coral is not properly attached to the base, the fragment may tilt or move, and the natural attachment of the coral to the base will be delayed or not occur, causing possible stunted growth.

Currently, the most common method for taking cuttings from coral colonies, after cutting off the fragments, is adhesively bonding the cuttings, using permanent fixing products, to plastic or concrete devices. Depending on the destination of the cuttings, the devices may themselves be attached, using the same adhesive agents, to supports placed in the destination environment, aquariums or reefs on the seabed.

The calcareous nature of the coral skeleton requires the use of adhesive agents such as epoxy resins (polyepoxides), cyanoacrylates, or adhesive mortars, which have the disadvantage of being toxic to some degree for coral and aquatic animals in general.

The paste forms of epoxy resins are often used to adhere coral cuttings because they are water resistant and may be handled in a marine environment. However, these adhesive agents are highly sensitizing and are recognized as being responsible for the majority of allergic eczemas developed in the context of professional activity. Moreover, the basic components, before polymerization, are toxic, and may in particular release esters derived from phthalic acid and various alcohols, which are detrimental to the growth of corals.

Cyanoacrylates allow a wide variety of materials to be joined together quickly. However, in addition to their toxicity problem, they also have the disadvantage of having a short shelf life, and of hardening on contact with water or even ambient moisture, which makes them a difficult, if not impossible, adhesive agent to be used in situ.

Adhesive mortars are generally composed of a mixture of air lime and cement. They are commonly used for construction work. These adhesive agents are very sensitive to changes in storage conditions and are therefore difficult to store in the long term. These products carry a risk of lung damage after prolonged inhalation. In addition, they produce an alkaline reaction in the presence of water, which can result in possible serious irritation in the event of contact with the eyes or skin. This alkaline reaction may also lead to weakening of structures where these agents are used, thus impacting the durability of bonding in contact with seawater.

In some cases, cuttings adhesively bonded to holding devices are then attached to reefs using metal nails and/or plastic zip ties. Here again, these methods are potentially traumatic and/or toxic for the coral.

As an alternative to methods involving adhesively bonding the cuttings to a holding device, there are devices allowing the cutting to be held by clamping it, without adhesive bonding, in a ring or valve, such as the “Frag Gripper by Reef Stew—the No Glue Frag Mounting System” sold by Vivid Creative Aquatics (vividcreativeaquatics.com/shop/frag-gripper-by-reef-stew/). However, this holding device must be adhesively bonded to a support or to a rod intended to be inserted in a support. Such a device, suitable for branching corals, is however not suitable for massive corals.

The supports on which the cuttings are usually adhesively bonded or attached, for example made of plastic or concrete, may also present a risk of toxicity and exacerbate coral reef damage factors, or may even have a negative impact on the environment owing to how they are made.

Thus, plastic materials such as polyethylene terephthalate or polyvinyl chloride may release endocrine disruptors such as antimony trioxide or phthalates. In areas polluted by plastic, it is observed that corals are more susceptible to the development of diseases. Contact between plastic debris and corals can cause injury to coral tissues, thus promoting infection by bacteria. Furthermore, certain additives present in plastics attract and promote the ingestion of plastic by coral polyps, increasing the risk of transmitting toxic elements to them while putting them off the genuine foods necessary for their development and survival.

Concrete, mainly made up of water, cement and sand, is used in all construction projects around the world. Sand often comes from the seabed or coastlines and its removal causes mechanical damage to reefs. Cement production releases the highest levels of CO₂ in the world, the main factor in global warming and, as a result, in damage to or even the disappearance of coral reefs.

### DISCLOSURE OF THE INVENTION

It may be relevant to have a device for holding a cutting or a fragment of coral which does not require a step of adhesive bonding, whether to attach the cutting or the fragment to the holding device or to attach the device to a support structure.

There is also a need to have a device for holding a cutting or a fragment of coral, or a support structure for such a device, which may be easily prepared in a material that is biodegradable, biocompatible for coral, and non-toxic for the environment.

There is also a need to have a device for holding a cutting or a fragment of coral, or a support structure for such a device, the biomimicry of which promotes the growth and development of coral.

There is also a need to have a device for holding a cutting or a fragment of coral, or a support structure for such a device, the surface texture of which is rough in such a way as to promote the growth and development of coral.

There is a need to have a device for holding a cutting or a fragment of coral, or a support structure for such a device, the surfaces of which are textured to exhibit a roughness capable of generating a friction effect when the surfaces come into contact and of helping to hold the device in the support structure, without adhesive bonding.

There is also a need to have a device for holding a cutting or a fragment of coral which may be suitable for holding a cutting or fragment of any type of coral, branching or massive, of various sizes.

There is also a need to have a device for holding a cutting or a fragment of coral, or a support structure for such a device, which may be prepared, in a simple manner, by 3D printing or by molding, and in particular by 3D printing.

There is also a need to have a device for holding a cutting or a fragment of coral, or a support structure for such a device, which makes it possible to reproduce as closely as possible the in situ natural development of coral.

There is also a need to have a device for holding a cutting or a fragment of coral, or a support structure for such a device, which does not have or the use of which does not generate or involve any agent potentially toxic to the environment or corals.

There is also a need to have a device for holding a cutting or a fragment of coral, or a support structure for such a device, requiring minimum handling to ensure that the cutting is held in the device and that the device is attached to the support structure.

There is also a need to have a device for holding a cutting or a fragment of coral, or a support structure for such a device, usable in an aquarium or on the seabed.

There is also a need to have a device for holding a cutting or a fragment of coral, which may be attached, without adhesive bonding, to natural reefs.

There is also a need to have a support structure the internal structure of which allows it to be filled and ballasted with water.

### SUMMARY OF THE INVENTION

The present invention aims to meet these various needs, in full or in part.

According to one of these first subjects, the invention relates to a device for holding a coral cutting, said device comprising:
a first hollow tubular element extending along a longitudinal axis and comprising a distal end, a proximal end, an inner face and an outer face, and
a second element arranged co-axially to the proximal end of the first element and comprising a flared part defining a surface comprising a plane diverging circumferentially around the longitudinal axis of the first element, and

said device having a textured surface.

According to one embodiment, said device has a textured surface on said inner face.

According to one embodiment, the flared part may comprise an edge defining, with the flat surface, a flange around said longitudinal axis. The flange may advantageously be deformable in a direction substantially parallel to the longitudinal axis of said tubular member.

According to one embodiment, the surface comprising a plane diverging circumferentially around the longitudinal axis may comprise at least four elongate protrusions, each protrusion comprising a distal end. The protrusions are arranged in the plane of said surface of the flared part and extend, with the flared part, in an arc of a circle, in the direction of the longitudinal axis of the hollow tubular element, in such a way as to form, with all of the distal ends positioned around said longitudinal axis, a holding member. In particular, the surface comprising a plane diverging circumferentially around the longitudinal axis may comprise at least 5 to at least 15, in particular at least 7 to at least 12, and in particular at least 10 elongate members.

The inventor found, surprisingly, that it was possible to prepare devices for holding a cutting or a fragment of coral configured such that the fragments of coral could be held in the device without adhesive bonding, and also that the device could be placed in and attached to a support, in an aquarium or on a seabed, without adhesive bonding.

The inventor also found that it was possible to prepare devices for holding a cutting or a fragment of coral, or a support structure for such a device, using a biodegradable polymer, such as a lactic acid polymer, comprising a calcium salt, such as calcium carbonate.

The inventor also found that it was possible to prepare devices for holding a cutting or a fragment of coral, or a support structure for such a device, by a three-dimensional printing method, making it possible to give the device or the support structure a textured surface.

The textured surface of the holding devices or the support structure advantageously makes it possible to generate biomimicry promoting the growth and development of the coral. The textured surfaces also advantageously have a roughness capable of generating a friction effect when they come into contact with each other in such a way as to promote holding and attachment, without adhesive bonding, of the device in the support structure.

The biodegradable nature of the material used advantageously allows good integration of the holding devices and the support structure into the natural environment while minimizing possible negative impacts.

The inventor unexpectedly found that it was possible to prepare devices for holding a cutting or a fragment of coral by giving them a shape making it possible to both attach and hold the coral cuttings and to insert and attach them in a support structure or a natural reef, all without adhesive bonding. In particular, the design of the holding devices allows the coral cutting to be held in the device by compression of the cutting by the part or parts of the device in contact with the cutting.

The preparation by 3D printing of the devices and support structure of the invention advantageously allows a manufacturing method that is simple and inexpensive, and easily adaptable to the varied dimensions of the coral cuttings.

The inventor surprisingly found that the biodegradable material used, and the method of manufacturing by 3D printing, made it possible to ensure flexibility of the holding devices giving the devices the property of holding the coral cutting in the device by compression of the cutting by the part or parts of the body of the device in contact with the cutting.

The inventor surprisingly found that the biodegradable material used, and the method of manufacturing by 3D printing, made it possible to confer, in a simple and inexpensive manner, a texture, or roughness, on the surface of the devices and support structure described herein.

One of the advantages of the invention is that it affords a device for holding a coral cutting, and also a support structure for such a device, which make it possible to hold a coral fragment without adhesive bonding.

Another of the advantages of the invention is that it affords a device for holding a coral cutting, and also a support structure for such a device, which have biomimetic properties promoting the growth of the coral.

A device as described herein may advantageously be arranged in and attached to any suitable support, in particular a support structure as described herein, in an aquarium or in a natural hole in a reef on a seabed without it being necessary to use a bonding agent.

According to another of its advantages, the devices and support structures described herein may be implemented using biodegradable materials that do not contain any elements that are toxic for the coral or its environment.

According to another of its advantages, the devices and support structures of the invention may be manufactured by 3D printing, which may facilitate the adaptation of their dimensions to the varied dimensions of the coral cuttings.

According to one embodiment, the first element may comprise at least one spike extending from the inner face toward the inside of said element.

According to one embodiment, the textured surface of a device may have a surface roughness making it possible to produce friction with a surface of the coral cutting and/or with a point of contact of a support structure. In particular, the textured surface may have an average surface roughness of at least 0.5 μm, in particular an average surface roughness ranging from 0.5 to 320 μm.

According to one embodiment, the device according to the invention may be formed of a material comprising at least one biodegradable polymer and at least one calcium salt.

The biodegradable polymer may be selected from a polylactic acid polymer, a glycolic acid polymer, a polyhydroxyalkanoate, a poly(alkylene succinate), polycaprolactone, polytrimethylene terephthalate (PTT), and a mixture thereof. In particular, the biodegradable polymer may be a lactic acid polymer.

The calcium salt may be an organic calcium salt. An organic calcium salt may be selected from calcium carbonate, calcium citrate, hydroxyapatite, calcium lysinate, calcium alginate, and a mixture thereof. In particular, the calcium salt may be calcium carbonate.

According to one embodiment, the device according to the invention may comprise a coral cutting.

According to another of its subjects, the present invention relates to a support structure for at least one device according to the invention, comprising a continuous surface comprising at least one hole configured to receive a hollow tubular element of a device according to the invention, said surface being a textured surface.

According to one embodiment, the structure may comprise an internal part made up of a plurality of cells in communication with one another and, directly or indirectly, with the holes.

According to one embodiment, the structure according to the invention may be formed of a material comprising at least one biodegradable polymer and at least one calcium salt.

According to one embodiment, the textured surface of a structure may have a surface roughness making it possible to produce friction with a device of the invention. In particular, the textured surface may have an average surface roughness of at least 0.5 μm, in particular an average surface roughness ranging from 0.5 to 770 μm.

According to one embodiment, the support structure may comprise at least one device according to the invention.

According to one embodiment, the support structure may comprise at least one device according to the invention inserted in a hole, the device comprising a flange, and said flange affixed to the surface of said structure.

According to another of its subjects, the present invention relates to a method for manufacturing a device for holding a coral cutting according to the invention or a support structure according to the invention, comprising at least one step consisting in 3D printing said device or said structure.

According to one embodiment, the printing material used in a method of the invention may be a biodegradable polymer comprising a calcium salt.

According to another of its subjects, the present invention relates to the use of a biodegradable polymer comprising at least one calcium salt for the manufacture of a device for holding a coral cutting according to the invention or a support structure according to the invention.

### BRIEF DESCRIPTION OF THE DRAWINGS

FIG. 1 depicts a device for holding a fragment or cutting of coral comprising a flared upper part defining a flange.

FIG. 2 depicts a cross section through a device according to FIG. 1.

FIG. 3 depicts a device for holding a fragment or cutting of coral comprising a flared upper part having elongate protrusions defining a holding member.

FIG. 4 depicts a cross section through a device according to FIG. 3.

FIG. 5 depicts a device according to FIG. 3 comprising a fragment of massive coral.

FIG. 6 depicts a device according to FIG. 1 comprising a fragment of branching coral.

FIG. 7 depicts a device according to FIG. 1 placed in a hole in a support structure, with the flange raised.

FIG. 8 depicts a device according to FIG. 1 placed in a hole in a support structure, with the flange affixed to the surface of the support structure.

FIG. 9 depicts a holding device according to FIG. 3 placed in a holding device according to FIG. 1.

FIG. 10 depicts a variant of FIG. 9.

FIG. 11 depicts a cross section through a device according to FIG. 1 comprising spikes arranged on the inner face of the hollow tubular element and on the upper face of the second element.

FIG. 12 depicts a support structure suitable for the devices of the invention.

FIG. 13 depicts a cross section of FIG. 12 revealing a honeycombed internal part.

FIG. 14 depicts a cross section through a support structure according to FIG. 12 comprising, in some of these holes, devices according to FIGS. 1 and 3 each comprising a coral fragment.

FIG. 15 illustrates the possible uses of the holding devices according to the invention either arranged in a support structure placed in an aquarium, or arranged in a natural reef present on a seabed.

FIG. 16 depicts the principle of 3D printing by superposition of layers of a polymer extruded from a printing nozzle.

FIG. 17 illustrates the variability of the average surface roughness as a function of the thickness of the layers of the polymer extruded from a printing nozzle.

FIG. 18 illustrates the 3D printing of a device according to FIG. 1.

### DETAILED DESCRIPTION

### Definitions

Note that, as used herein and in the appended claims, the singular forms “a” and “the” include plural referents unless the context clearly indicates otherwise. Thus, for example, reference to “a device” includes reference to a plurality of devices, and reference to “a structure” includes reference to a plurality of structures, and so on.

The expression “comprising a” must be understood as being synonymous with “comprising at least one”.

The terms “around” or “approximately”, as used herein in connection with a numeric value or a parameter, refer to the usual error interval, known to those skilled in the art in the technical field, for the measurement of this value or this parameter. Reference to “around” “a value or a parameter” includes and describes embodiments using that value or that parameter. In some embodiments, the term “around” refers to ±10% of a given value. However, when the value in question refers to an indivisible object that would lose its identity when subdivided, then “around” refers to ±1 of the indivisible object.

Aspects and embodiments of the present invention described herein include the variants “having”, “comprising”, “consisting of” and “consisting essentially of” of these aspects and embodiments. The terms “have” and “comprise” used in connection with an element, or variants such as “has”, “having”, “comprises” or “comprising”, are understood to imply the inclusion of the element(s) mentioned without excluding other elements. The term “consisting of” implies the inclusion of the indicated element to the exclusion of any additional element. The term “consisting essentially of” implies the inclusion of the stated element, and possibly other elements where these other elements do not materially affect the fundamental feature(s) of the disclosure. It is understood that the various embodiments of the disclosure using the term “comprising” or an equivalent encompass embodiments where this term is replaced by “consisting of” or “consisting essentially of”.

In the description, the terms “essentially” or “substantially” used in conjunction with a feature are intended to define a set of variants of that feature that are largely, but not entirely, similar to that feature. The difference between the set of variants of the given feature and the given feature is such that in all of the embodiments corresponding to the set of variants of the given feature, the nature and function of the feature are not materially affected. For example, the term “substantially” referring to a position, for example “substantially parallel”, is used to describe a set of positions that are close to, but not identical to, the parallel position.

It is understood that certain features of the invention, which are, for the sake of clarity, described as separate embodiments, may also be combined in a single embodiment. Conversely, different features of the invention, which are, for the sake of brevity, described in the context of a single embodiment, may also be implemented separately or in suitable sub-combinations.

Unless stated otherwise, all technical and scientific terms used herein have the same meaning as generally understood by those skilled in the art in the field of the invention. All methods and materials similar or equivalent to those described herein may also be used in the implementation of the invention. All publications mentioned herein are incorporated by reference to describe the methods and/or materials in connection with which such publications are cited.

The list of sources, ingredients and components described below are enumerated such that combinations and mixtures thereof are also contemplated and included herein. The lists given may be read and interpreted to mean “selected from the group consisting of” the list of given compounds or items, “and mixtures thereof”.

Each maximum numeric limitation given in the description includes all lower numeric limitations, as if such lower numeric limitations were expressly written. Each minimum numeric limitation given in the description includes all higher numeric limitations, as if these higher numeric limitations were expressly described herein. Each numeric range given in the description includes the narrower numeric ranges included in that given numeric range, as if those numeric ranges were expressly described herein.

Reference is made in the description to given materials, compounds or equipment with a particular trade name. The invention is not limited to the use of these specific materials, compounds or compounds and includes any equivalent known in the field.

### Holding Device

A holding device according to the invention (1, 21) for holding a coral cutting may comprise at least:
a first hollow tubular element (2) extending along a longitudinal axis and comprising a distal end (3), a proximal end (4), an inner face (13) and an outer face (5), and
a second element (6) arranged coaxially to the proximal end of the first element and comprising a flared part (7) defining a flat surface (10) comprising a plane diverging circumferentially around the longitudinal axis of the first element (2), and
said device having a textured surface (8).

The first element comprises, between its distal (3) and proximal (4) ends, a body (9) defined by the inner face (13) and the outer face (5) of this first element.

The second element (6) of a device of the invention may comprise a flared part comprising an edge (11) defining, with the flat surface (10) of the flared part (7), a flange (12) around said longitudinal axis. The flange (12) may be in one piece and form a continuous surface comprising a plane diverging circumferentially around the longitudinal axis of the first element. Alternatively, according to an embodiment not shown, the flange (12) may have interruptions arranged substantially perpendicular to its edge. The interruptions may take the form of incisions or notches extending from the edge of the flange to the proximal end of the first element.

The flange (12) may be deformable in a direction substantially parallel to the longitudinal axis of the first element (2). Advantageously, the flange (12) may be deformable in the direction of the distal end (3) of the first element (2). Thus, once placed in a support, for example a support structure as defined below or a natural reef on a seabed, the deformable flange (12) may be folded downward, toward the end distal (3) of the first element, and become affixed to the surface of the support. By becoming affixed to the surface of the support, the flange promotes, through the friction forces generated by its textured surface, attachment and holding of the device in its support.

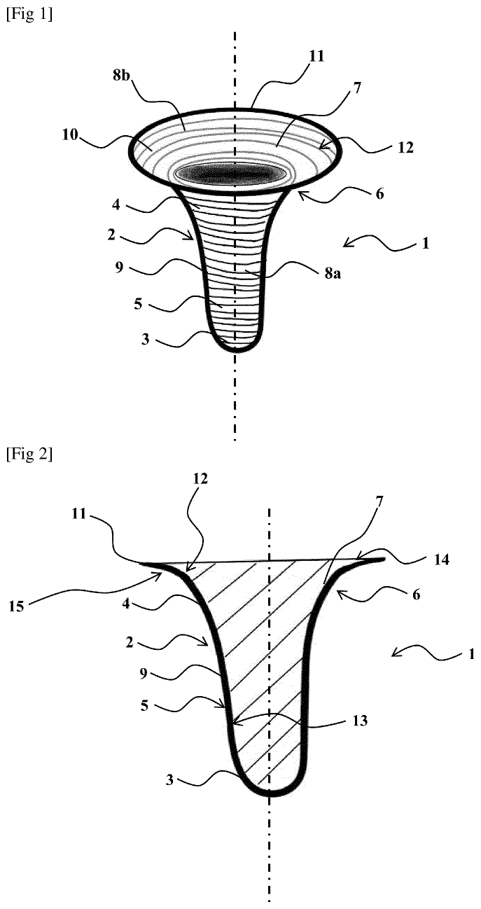

According to one embodiment, shown in FIG. 1, a holding device (1) for holding a coral cutting according to the invention may comprise at least a first hollow tubular element (2) extending along a longitudinal axis and comprising a distal end (3), a proximal end (4), an inner face (not visible) and an outer face (5), and a second element (6) arranged coaxially to the proximal end (4) of the first element (2) and comprising a flared part (7) defining a flat surface (10) comprising a plane diverging circumferentially around the longitudinal axis of the first element, the flared part (7) further comprising an edge (11) defining, with the flat surface (10), a flange (12) around said longitudinal axis, and the device may have a textured surface (8a, 8b). Advantageously, the flange (12) is deformable in a direction substantially parallel to the longitudinal axis of said tubular member (2).

Such a device, with a flange, may be referred to in the description below as a “valve” device.

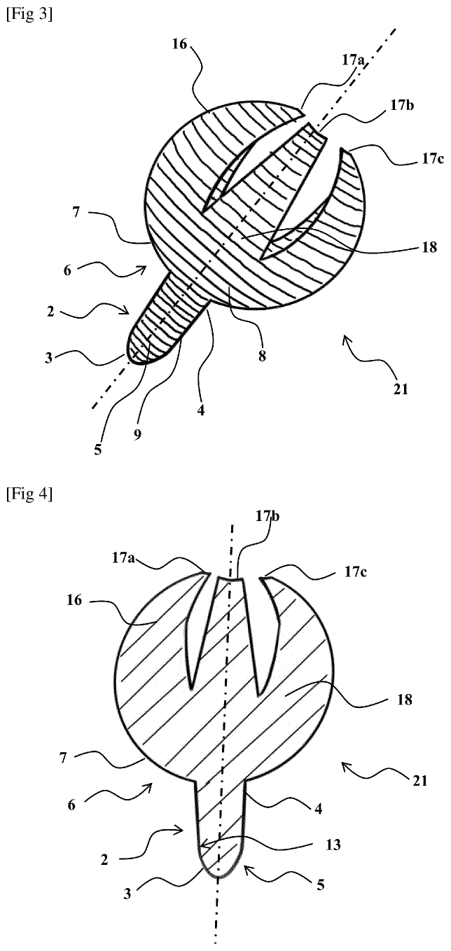

FIG. 2 shows a cross section through a holding device (1) for holding a coral cutting comprising at least a first hollow tubular element (2) extending along a longitudinal axis and comprising a distal end (3), a proximal end (4), an inner face (13) and an outer face (5), and a second element (6) arranged coaxially to the proximal end (4) of the first element (2) and comprising a flared part (7) defining a flat surface (10) comprising a plane diverging circumferentially around the longitudinal axis of the first element (2), the flared part (7) further comprising an edge (11) defining, with the flat surface (10), a flange (12) around said longitudinal axis, and the device may have a textured surface.

The first element comprises, between its distal (3) and proximal (4) ends, a body (9) defined by the inner face (13) and the outer face (5) of this first element.

Considered as a whole, a device according to the invention comprises a wall made up, on the one hand, of the inner face (13) of the first hollow tubular element (2) which is extended by the upper face (14) of the second element (6) and, on the other hand, of the outer face (5) of the first element (2) which is extended by the lower face (15) of the second element (6).

The wall of the device comprises an inner face and an outer face. The inner face of the wall is formed by the inner face (13) of the first hollow tubular element (2) and the upper face (14) of the second element (6). The outer face of the wall is formed by the outer face (5) of the first hollow tubular element (2) and the lower face (15) of the second element (6). The outer and inner faces represent, together, the surface of the device of the invention.

The wall of a device has the flexibility and rigidity necessary to allow a coral fragment to be inserted in the device and then ensure that it is held, and also to allow the device to be inserted and held in a hole, either in a support structure or in a reef on a seabed.

FIG. 3 shows a variant embodiment of a device of the invention (21). A device of the invention (21) may comprise a second element (6) the flared part (7) of which comprises at least four elongate protrusions (16) (in the figure the fourth end is not visible because it is hidden), each protrusion comprising a distal end (17). The protrusions are arranged in the plane of the surface of the flared part (7) and extend, with the flared part (7), in an arc of a circle, in the direction of the longitudinal axis of the hollow tubular element (2), in such a way as to form, with all of the distal ends (17a, 17b, 17c, the fourth end is not visible in the figure because it is hidden by the protrusion terminating in the end 17b) positioned around said longitudinal axis, a holding member.

The first element comprises, between its distal (3) and proximal (4) ends, a body (9) defined by the inner face (13) and the outer face (5) of this first element.

The surface of the device according to the invention (21) is textured (8).

In particular, the flared part (7) may comprise at least 5 to at least 15, in particular at least 7 to at least 12, and in particular at least 10 elongate protrusions (16).

The protrusions comprise a distal end (17) and a base (18) located in the flared part of the second element.

The elongate protrusions may be substantially flat. Alternatively, they may be substantially tubular, hollow or solid. Advantageously they are in solid tubular form. Advantageously still, they are substantially flat.

The elongate protrusions may have a constant cross section between the flared part of the second element and their distal end. Alternatively, the cross section may decrease substantially toward the distal ends of the protrusions, in such a way as to give the distal ends a pointed shape.

Advantageously, the elongate protrusions (16) are substantially flattened, with a cross section decreasing between the base (18), located in the flared part (7) of the second element (6), in such a way as to give the distal ends (17) a pointed, or substantially pointed, shape.

The elongate protrusions (16) may extend, substantially in the plane of the surface of the flared part (7) of the second element (6), linearly, such that the distal end (17) of the protrusion (16) is in a position substantially aligned with the position of the base (18).

Alternatively, according to a variant embodiment, the elongate protrusions may extend, substantially in the plane of the surface of the flared part of the second element, in a sigmoidal shape or a twist shape, such that the distal end of the protrusion is in a position that is offset, laterally, relative to the position of the base.

FIG. 4 shows a cross section through a device according to the invention (21) shown in FIG. 3.

According to a variant embodiment, a device for holding a coral cutting according to the invention (21) comprises:
a first hollow tubular element (2) extending along a longitudinal axis and comprising a distal end (3), a proximal end (4), an inner face (13) and an outer face (5), and
a second element (6) arranged coaxially to the proximal end (4) of the first element (2) and comprising a flared part (7) defining a flat surface (10) comprising a plane diverging circumferentially around the longitudinal axis of the first element (2), the flared part (7) comprising at least four elongate protrusions (16), each protrusion comprising a distal end (17), said protrusions being arranged in the plane of said surface of the flared part (7) and extending, with said flared part (7), in an arc of a circle, in the direction of the longitudinal axis of the hollow tubular element (2), in such a way as to form, with all of the distal ends (17a, 17b, 17c) positioned around said longitudinal axis, a holding member,

said device having a textured surface (8).

A device as described above, with protrusions, may be referred to in the rest of the description as a “ring” device.

The dimensions of “valve” or “ring” type devices are variable and depend on the dimensions of the coral cuttings to be transplanted. It is easy to obtain holding devices of the invention adapted to the dimensions of the coral fragments using the 3D printing manufacturing method described below. Although there are no limits on the dimensions of the holding devices of the invention, in practice it is not beneficial to cut coral fragments with dimensions greater than 50 cm in their greatest length.

In their greatest length, the devices of the invention may have a dimension ranging from around 1 cm to around 25 cm, in particular from around 2 cm to around 20 cm, from around 5 cm to around 15 cm, from around 8 cm to around 10 cm.

In their greatest width, the devices of the invention may have a dimension ranging from around 0.5 cm to around 20 cm, in particular from around 1 cm to around 15 cm, from around 4 cm to around 12 cm, or from around 8 cm to around 10 cm.

According to one variant embodiment, the first hollow tubular element may be closed at its distal end. Alternatively, it may be open at its distal end. The opening may have a diameter substantially equivalent to the width of the body of the first element. Alternatively, the opening may have a diameter smaller than the width of the body of the first element. According to yet another variant, the distal end may comprise at least one or a plurality of holes, at least two, of variable dimensions and shape, for example circular.

The first hollow tubular element may have a section of variable shape. It may be substantially circular, square, rectangular, trapezoidal, triangular, or even ellipsoidal. Advantageously, it is substantially circular. The section of the first tubular member may be constant all along the length of the member or may vary in its shape along this length, for example having a substantially circular section in a first segment of the length of the tubular element, then having a substantially square section in a subsequent segment.

Advantageously, the section of the first hollow tubular element is substantially circular and constant all along the length of the element.

The surface of the body of the hollow tubular element, between its proximal and distal ends, may be continuous or have openings of various dimensions and sizes, in particular circular. In particular, the surface of the body of the hollow tubular element is continuous.

The presence of an opening at the distal end and/or of at least one hole at the distal end and/or of at least one hole in the body of the first element advantageously allows sea water or aquarium water to circulate in the holding device and more easily provide the coral cutting with the nutrients necessary for its growth and development.

A device of the invention, for example (1) or (21), as described herein may be made in one piece. In such a configuration, the second element (6) may constitute an extension of the proximal part (4) of the first element (2).

Alternatively, a device of the invention, for example (1) or (21), as described herein may be made up of at least two parts represented, respectively, by the first (2) and second (6) elements. In such a configuration, the first (2) and second (6) elements may be assembled by any method known to those skilled in the art, for example by welding.

Advantageously, a holding device according to the invention is made in one piece.

A device of the invention, for example (1) or (21), as described herein is advantageously intended to hold a coral fragment or cutting. The device is then placed in an environment allowing the cutting to develop and grow into a new colony of corals. The expressions “coral fragment” or “coral cutting” are used herein interchangeably to designate a piece of coral taken from an individual with a view to its reproduction via cuttings. Taking cuttings is a method of vegetative propagation consisting in giving birth to a new individual from an isolated member or fragment of a member. The device is also intended to be placed by insertion in a hole, either in a support structure or in a natural reef present on a seabed, so as to provide the coral fragment with the environment necessary for its growth and its development.

The function of inserting a device according to the invention, for example (1) or (21), in an attachment hole is performed by the first hollow tubular element (2). The function of holding a coral cutting by the device (1) is performed by the second element (6) arranged coaxially to the proximal end (4) of the first element (2) and comprising a flared part (7), and by the lumen, or internal part of the first hollow tubular element (2). The function of holding a coral cutting by the device (21) is performed by the second element (6) arranged coaxially to the proximal end (4) of the first element (2) and comprising a flared part (7), and by the elongate protrusions (16) the distal ends (17) of which positioned around said longitudinal axis form a holding member.

A “ring” device as described above may be advantageously suitable for holding a fragment of branching or massive coral. In such an implementation, the coral fragment may be inserted between the distal ends of the elongate protrusions. The insertion of the coral fragment is performed in such a way as to keep at least one, and preferably both ends of the fragment held between two protrusions and extending outward from the device. In particular, a device of the invention (21) with elongate protrusions (16) may be suitable for massive corals. FIG. 5 shows a device according to the invention (21) comprising a fragment of massive coral (22) clamped in the elongate protrusions (16).

A “ring” type device may have a rigid wall, having for example a hardness of around 95 to around 98 Shore A, and in particular of around 96 Shore A to around 97 Shore A. In particular, such a device may have a rigid wall having a hardness of around 98 Shore A.

A “valve” device as described above may be advantageously suitable for holding a fragment of branching coral. In such an implementation, the coral fragment may be inserted along the entire length of the first element. Holding of the coral may be promoted by the presence of spikes, as described below. The coral fragment is inserted in such a way as to keep part of the fragment emerging above the flared part of the second element.

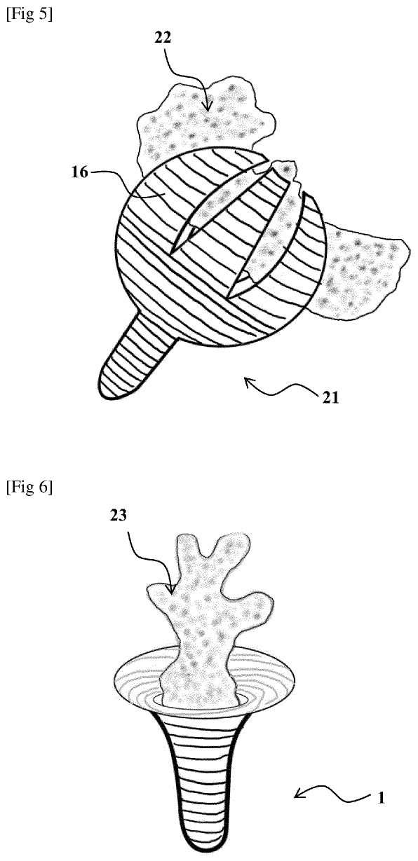

A device of the invention with a flange may be particularly suitable for branching corals. FIG. 6 shows a device according to the invention (1) comprising a fragment of branching coral (23).

A “valve” type device may have a wall having, for example, a hardness ranging from around 85 to around 98 Shore A, and in particular from around 90 to around 95 Shore A, and in particular of around 92 Shore A. In particular, such a device may have a rigid wall having a hardness of around 92 Shore A.

Once the coral fragment has been inserted in a “valve” type holding device, the device may be placed in a support structure, for example a support structure as defined below or a natural reef on a seabed, the deformable flange may be folded downward, toward the distal end of the hollow tubular element, and become affixed to the surface of the support. By becoming affixed to the surface of the support, the flange promotes, through the friction forces generated by its textured surface, attachment and holding of the device in its support.

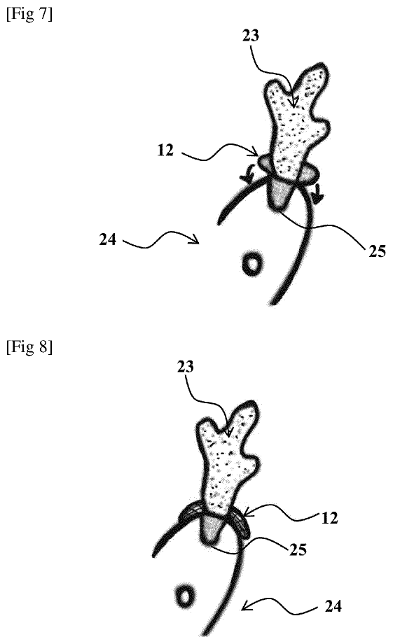

FIGS. 7 and 8 show a device according to the invention (1) containing a fragment of branching coral (23) inserted in a hole (25) in a support (24). FIG. 7 shows the device with the flange (12) raised in the initial position. FIG. 8 shows the device with the flange (12) deformed and affixed to the surface of the support (24).

Alternatively, a “valve” device may be suitable for holding a “ring” device itself comprising a cutting of branching or massive coral.

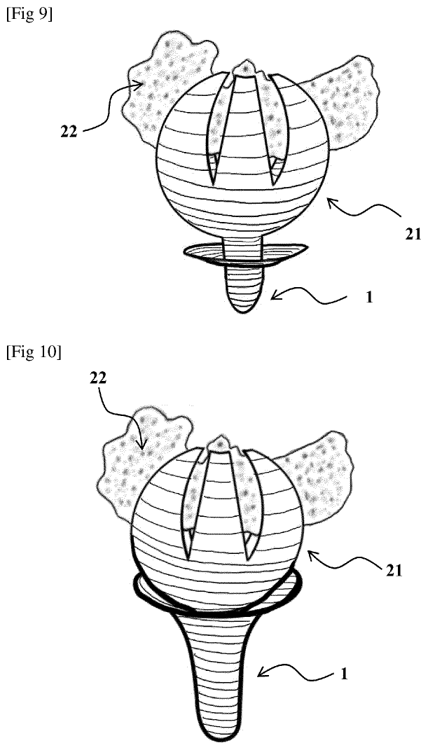

FIGS. 9 and 10 show a “ring” type device of the invention (21) comprising a massive coral fragment (22) inserted in a “valve” type holding device (1).

A “valve” device or a “ring” device as described above may also comprise at least one, and in particular a plurality, of spikes arranged at least on the inner face of the wall of the device.

According to one embodiment, the spike(s) may be arranged on the inner face of the first element. The spike(s) may be arranged at the proximal end. Alternatively, or additionally, they may be arranged over the entire internal surface of the body of the first element, or also at the distal end.

According to one variant embodiment, the spike(s) may be arranged on the upper face of the second element.

The spikes may be arranged on the circumference of the first hollow tubular element, or longitudinally along the longitudinal axis of the first element, or on the circumference and along the longitudinal axis in such a way as to be arranged regularly on the inner face of the first element. The density of spikes is adjusted in such a way as to increase the hold on the coral fragment (or any other element inserted in a device of the invention) without preventing or hindering its insertion.

The presence of the spikes advantageously makes it possible to promote holding of the coral fragment inserted in the hollow tubular element, or where appropriate holding of a second device for holding a coral fragment inserted in the first.

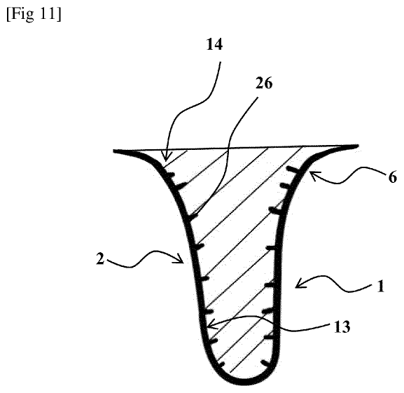

FIG. 11 shows a cross section through a device according to the invention (1) comprising a plurality of spikes (26) arranged on the inner face (13) of the first element (2) and on the upper face (14) of the second element (6).

A device according to the invention has a textured surface (8). The textured surface may have an average surface roughness capable of producing friction with a surface of the coral cutting and/or with a point of contact of a support structure. For the purposes of the invention, the term “textured” means that the surface of the wall is rough. The texturing or roughness of the surface of the wall is present on the outer face of the wall or on its inner face. Advantageously, the texturing or roughness is present on the inner face and on the outer face.

The texturing of the surface of the inner face of the device makes it possible, through a phenomenon of friction generated between the texture of the surface and the surface of the coral cutting, to immobilize and hold the cutting in the device.

The texturing of the surface of the outer face of the device makes it possible, through a phenomenon of friction generated between the textured surface and the surface of a support in which the device is inserted, to immobilize and hold the device in the support.

The term “textured” does not imply the use of any particular material or manufacturing method (for example, a finish or a coating applied thereto). The term “textured” is used to refer to a high-friction surface profile as opposed to a smooth or polished surface profile. A textured face, or surface, may be made up of numerous discrete constituents in proximity to one another, together defining a plurality of convex and concave elements. Concave and convex elements are not limited to any particular shape. A concave element suitable for the invention is not limited to any particular shape and may, for example, have the shape of a hollow, a valley, a cavity, a recess, a groove, a striation, or a depression. A convex element suitable for the invention is not limited to any particular shape and may, for example, have the shape of a bump, a lump, a projection, a corner, a protuberance, a bulge, an elevation, or an excrescence.

The texturing is not limited to any particular shape. Texturing suitable for the invention may, for example, have the shape of a set of furrows, striations, grooves, scores, meshes, a geometric network, or interlacing.

According to one embodiment, the texturing of the surface of a device of the invention and the texturing of the surface of a support, for example a support structure of the invention, may have identical or similar configurations such that the convex elements on the surface of the device can fit into the concave elements on the surface of the support, and that the convex elements on the surface of the support can fit into the concave elements on the surface of the device. Identical or similar configurations of texturing generally allow greater surface friction to be generated, since opposing constituents are easily placed in interfering/interlocking contact with one another.

According to an advantageous embodiment, the surface of a device and the surface of a support structure have texturing formed by a set of furrows, striations or grooves arranged, substantially, parallel to one another.

The texturing of the surface of a device according to the invention may be defined by a surface roughness, in particular an average surface roughness. Surface roughness corresponds to the irregularities present on a surface and caused by differences in level. Surface roughness may be established by measuring a surface profile using a roughness measurement device. Various roughness measurement methods may be applied. As examples of methods for measuring surface roughness, in particular average surface roughness, mention may be made of contact-type methods, such as the stylus method, or optical methods, for example with an optical profilometer.

In what is referred to as the stylus method, a sensor tip is used at a constant speed across the surface of a device. The tip scans the surface point by point. Contact-type measurement of the average surface roughness may for example be obtained using equipment such as the Surftest SJ-210 or Surftest SJ-410 marketed by the company Mitutoyo.

Optical measurement of the average surface roughness may for example be obtained using equipment of optical profilometer type, for example the NewView™ 9000 optical profilometer from Zygo Corporation, or using a Rainbow white light chromatic confocal sensor marketed by the company OGP.

According to DIN EN ISO 4288 (at the date of filing), a roughness profile is measured in 5 individual measurement sections. Most roughness characteristics such as, for example, the arithmetic average roughness value (Ra), the mean roughness depth (Rz) or the maximum roughness depth (Rmax) are calculated in an individual measurement section (the length of an individual measurement section is numerically equal to the upper limit wavelength). Characteristic values such as the material ratio (Rmr) or the total height of the roughness profile (Rt) are taken into account over the entire roughness profile. The roughness characteristics or roughness parameters refer to the international standard DIN EN ISO 4287 (at the date of filing).

The average roughness Ra is defined as the arithmetic average value of the absolute values of the profile deviations within the reference section.

The average surface roughness of a device of the invention may be measured parallel to the longitudinal axis of the element.

The average surface roughness of a device of the invention may be measured perpendicularly to the striations present on the surface.

The textured surface of a device according to the invention may have an average surface roughness of at least 0.5 μm, in particular a surface roughness ranging from around 0.5 to around 320 μm. In particular, a device of the invention may have an average surface roughness ranging from around 1 μm to around 300 μm, from around 2 μm to around 250 μm, from around 4 μm to around 200 μm, from around 8 μm to around 150 μm, from around 10 μm to around 120 μm, from around 15 μm to around 100 μm, from around 20 μm to around 80 μm, or from around 30 μm to around 50 μm.

A device according to the invention may have an average surface roughness of around 0.5 μm, around 1 μm, around 2 μm, around 5 μm, around 8 μm, around 10 μm, around 15 μm, around 20 μm, around 30 μm, around 40 μm, around 50 μm, around 80 μm, around 100 μm, around 120 μm, around 150 μm, around 180 μm, around 200 μm, around 250 μm, around 280 μm, around 300 μm, or around 320.

As described in detail below, the surface roughness, or texturing, of a device of the invention is determined, in particular, by the parameters of the method for manufacturing the device. Thus, each manufacturing method corresponds to an expected surface roughness.

The wall of a device of the invention has a flexibility or a rigidity suitable for inserting and holding a coral fragment in the device, and inserting and holding the device in a support, natural or manufactured. The flexibility or the rigidity of a device of the invention may be measured using the Shore hardness scale. Hardness may be measured using a Shore durometer. Such a device determines the indentation depth of a standardized indenter, a frustoconical tip, when applied to a sample; when penetrating the sample it causes a reaction on a calibrated metal spring. The scale for measuring the hardness of the wall of a device according to the invention is the Shore A scale. The measurement of the hardness on the Shore A scale may be carried out with a truncated cone having a cone angle of 35°, a spring force of 8.065 N and a pressure force of 12.5 N.

The holding devices may be colored to promote biomimicry with coral fragments. The coloring of the devices according to the invention is obtained by coloring the material used to manufacture them, as described in detail below.

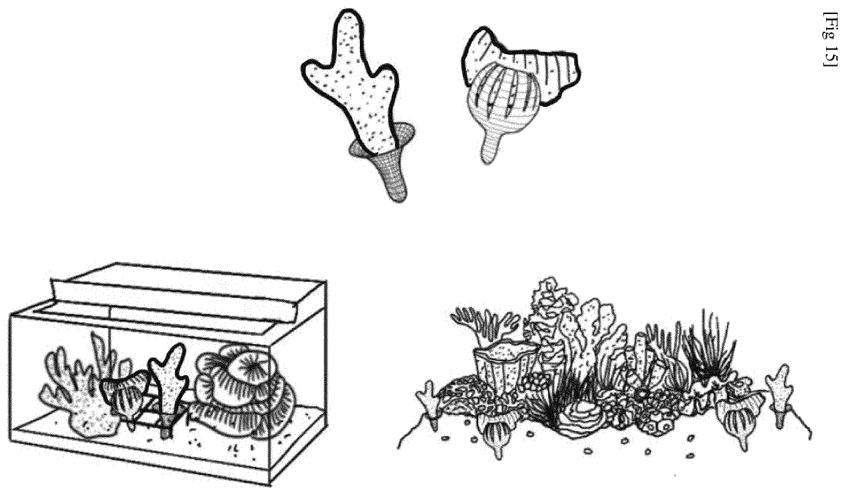

As shown in FIG. 15, the devices of the invention may be inserted in supports, either artificial, such as the support structure described below, or natural, such as a reef lying on a seabed.

### Support Structure

One of the subjects of the invention relates to a support structure for at least one device of the invention. Such a structure comprises a continuous surface comprising at least one hole configured to receive the distal end of a device as described herein. The surface of the structure is textured.

A support structure may have any possible shape. In particular, it may have protuberances and hollows intended to mimic the natural relief of a coral reef. Alternatively, it may have a geometric shape, such as a cube, a parallelepiped, or a polygon comprising at least one face of dimension sufficient to allow the structure to be placed stably at the bottom of an aquarium or on a seabed.

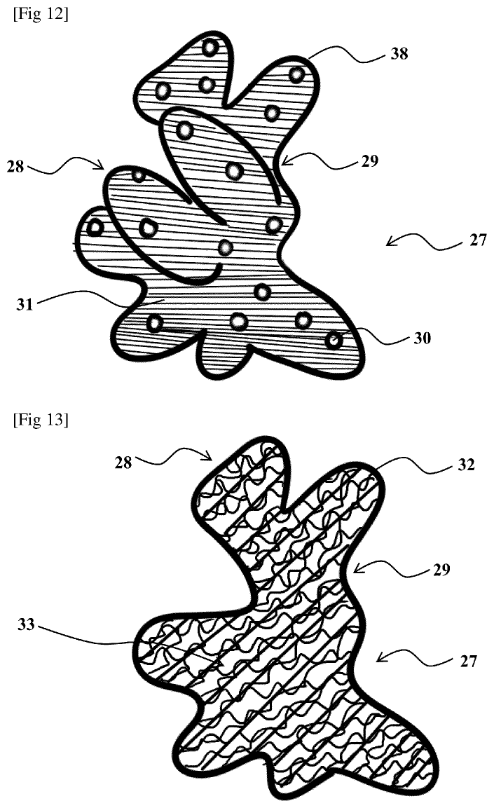

FIG. 12 shows a support structure (27), of any shape, having protuberances (28) and recesses (29), comprising a continuous surface (38) comprising a plurality of holes (30), configured where appropriate to receive a hollow tubular element (2) of a device (1, 21), and the surface being textured (31).

The texturing of the surface of the support structure according to the invention may have the same characteristics as the texturing of the surface of a device of the invention, in particular as described above, and the average surface roughness may also be measured as described above for the devices.

The textured surface of a support structure according to the invention may have an average surface roughness of at least 0.5 μm, in particular an average surface roughness ranging from around 10 to around 770 μm. In particular, a device of the invention may have an average surface roughness ranging from around 15 μm to around 700 μm, from around 20 μm to around 600 μm, from around 40 μm to around 500 μm, from around 50 μm to around 400 μm, from around 80 μm to around 300 μm, from around 100 μm to around 250 μm, from around 120 μm to around 200 μm, or from around 150 μm to around 180 μm.

A support structure according to the invention may have an average surface roughness of around 0.5 μm, around 10 μm, around 15 μm, around 20 μm, around 40 μm, around 50 μm, around 80 μm, around 100 μm, around 120 μm, around 150 μm, around 180 μm, around 200 μm, around 250 μm, around 300 μm, around 400 μm, around 500 μm, around 600 μm, around 700 μm, or around 770 μm.

According to an advantageous embodiment, the surface (38) of a support structure (27) has texturing (31) made up of a set of furrows, striations or grooves arranged, substantially, parallel to one another.

The surface of a support structure (27) according to the invention comprises at least one hole (30) configured to receive the hollow tubular element (2) of a device according to the invention (1, 21).

In particular, a support structure has a plurality of holes (30). The holes are in random or disordered arrangements on the surface of the structure. Alternatively, the holes may be positioned in an orderly manner.

The holes are positioned at a distance from one another in such a way as to allow each coral cutting present in a holding device of the invention placed in each of the holes to develop without interfering with the growth and development of neighboring cuttings. For example, the holes may be positioned at a distance of at least 5 cm, in particular at least 8 cm, in particular at least 10 cm, in particular at least 12, or at least 15 cm from one another. The distance between two neighboring holes may range from around 5 cm to around 15 cm, in particular from around 8 cm to around 12 cm, or may be around 10 cm.

According to one variant embodiment, the support structure may be solid. In this variant, the holes are hollowed or drilled in the mass.

According to another variant embodiment, the support structure may be hollow and include a wall. In this variant, the holes may be hollowed or drilled in the wall of the hollow structure. Alternatively, the hollow structure may, for example, be molded by injection molding or extrusion blow molding in a mold comprising spikes for forming the holes.

According to yet another variant embodiment, the support structure may comprise a wall and an internal part made up of a plurality of cells. The cells are advantageously in communication with one another. Such a structure may be obtained by 3D printing with a honeycomb (or hexagonal) type infill. In 3D printing, infill reflects the degree of filling of the printed product. The denser the infill pattern, the more the internal part of the printed product will be filled. A support structure according to the invention may comprise an infill density ranging from 1 to 50%.

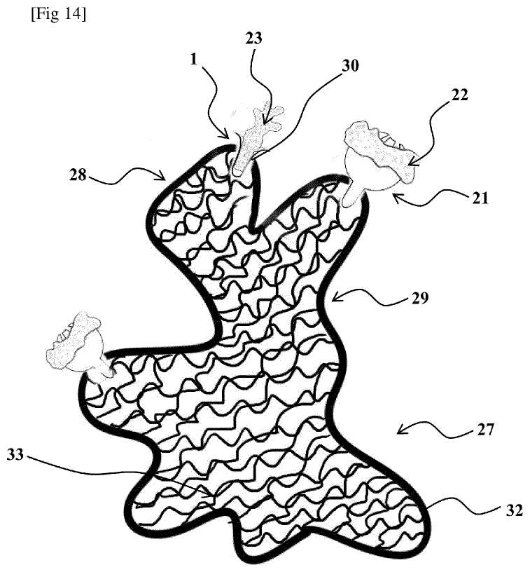

FIG. 13 shows a cross section through a support structure (27), of any shape, having protuberances (28) and recesses (29), comprising a wall (32) and an internal part made up of a plurality of cells (33).

FIG. 14 shows a cross section through a support structure (27), of any shape, having protuberances (28) and recesses (29), comprising a wall (32) and an internal part made up of a plurality of cells (33). The structure comprises a plurality of holes (30) in which devices (1) or (21) for holding a coral fragment (22) or (23) are inserted.

In the case of a hollow structure or a structure comprising a honeycombed internal part, advantageously the holes may be open to the interior of the structure in such a way as to allow communication between the exterior and the interior of the structure. This can allow the structure submerged in an aquarium or placed on a seabed to be filled with water. The structure thus filled is ballasted and may sit stably at the bottom of the aquarium or on the seabed.

According to one variant embodiment, a support structure according to the invention may comprise an internal part made up of a plurality of cells in communication with one another and, directly or indirectly, with the holes. Each cell constitutes a cavity comprising a wall shared with at least one adjacent cell and at least one opening allowing communication between the cavity of the cell and a cavity of at least one adjacent cell.

The number of cells in the internal part of a support structure of the invention obtained by 3D printing, and their dimensions, depend in particular on the type of infill chosen and the density thereof. The density and model of infill are adjusted to obtain the best compromise in terms of solidity, weight and cost of the part produced and to ensure that the support structure fills with water when it is immersed.

The dimensions of a support structure for “valve” or “ring” type devices may vary and may depend, in particular, on the final destination of the support structure—aquarium or seabed—and on the number of holding devices to be put in place, etc. In practice, a support structure may have dimensions from a few centimeters in height, width and length to several tens of centimeters. For structures with particularly large dimensions, these may be expressed in meters.

A support structure according to the invention may comprise at least one device according to the invention. Preferably, the structure is submerged, then the coral cutting holding devices according to the invention are arranged in the holes. In the case of a hollow structure or a structure with a honeycombed internal part, this advantageously allows filling and ballasting of the structure with water.

According to one embodiment, in the case of use of a “valve” type device, either as a device for holding a coral cutting directly or as an indirect holding device which thus comprises a “ring” type device containing a cutting, the flange may be affixed, by deformation, to the surface of the structure. The friction generated by placing in contact the textured surfaces of the flange and of the support structure advantageously allows stable positioning of the holding device in the structure.

The devices for holding a coral cutting according to the invention are textured over their entire surface. The contact between the textured surface of the device of the invention and the edge of the hole in which it is inserted makes it possible to generate friction advantageously allowing stable positioning of the holding device in the structure.

As in the case of the holding devices, a support structure according to the invention may be colored so as to promote biomimicry with coral fragments. Preferably, a support structure according to the invention may mimic, both in its shape and in its color, the appearance of a common and resistant coral, such as Porites furcata, to signal to adjacent corals that it is an environment conducive to their development. The coloring of the support structures according to the invention may be obtained by coloring the material used to manufacture them, as described in detail below.

### Biodegradable Polymers

A holding device and/or a support structure according to the invention may be made of a biodegradable polymer comprising at least one calcium salt.

Thus, according to one of its subjects, the invention relates to the use of a biodegradable polymer comprising at least one calcium salt for the manufacture of a device for holding a coral cutting according to the invention or of a support structure according to the invention.

A polymer is a macromolecule made up of a chain of repeating units. A biodegradable polymer is a polymer that breaks down quickly over time into biocompatible (or environmentally friendly) by-products.

A biodegradable polymer suitable for the invention may be adapted to be used in a method for manufacturing a device or a support structure according to the invention by molding, for example by injection molding or extrusion blow molding, or by 3D printing.

Advantageously, a biodegradable polymer comprising at least one calcium salt may be suitable for a method for manufacturing the devices and structures of the invention by 3D printing.

Polymers that may be used in 3D printing are supplied in the form of a filament.

A polymer suitable for the invention may have an extrusion temperature of from 150° C. to 220° C., in particular from 180° C. to 190° C.

A biodegradable polymer suitable for the invention may be chosen from a polylactic acid polymer, a glycolic acid polymer, a polyhydroxyalkanoate, a poly(alkylene succinate), polycaprolactone, polytrimethylene terephthalate (PTT), and mixtures thereof.

A polyhydroxyalkanoate may be chosen from polyhydroxybutyrate (PHB), poly(3-hydroxybutyrate-co-3-hydroxyvalerate) (PHBV), poly(3-hydroxybutyrate-co-3-hydroxyhexanoate) (PHBHHx), and mixtures thereof.

A poly(alkylene succinate) may be chosen from poly(ethylene succinate) (PESu), poly(propylene succinate) (PPSu), poly(butylene succinate) (PBSu), and mixtures thereof.

In particular, a biodegradable polymer may be a polylactic acid (PLA) polymer.

A calcium salt suitable for the invention may be an organic calcium salt. An organic salt may be selected from calcium carbonate, calcium citrate, hydroxyapatite, calcium lysinate, and mixtures thereof. In particular, a calcium salt is calcium carbonate. Calcium carbonate is an element that makes up the skeleton of coral.

Calcium carbonate may be introduced into the polymer in any form suitable for the invention. In particular, the calcium carbonate may be introduced into the polymer in the form of ground Ostreidae shell, such as for example ground oyster shell.

The particles of calcium salts, in particular calcium carbonate, have a size that does not interfere with the diameter of the extrusion nozzle of the 3D printer. For example, the size of the particles of calcium salt, in particular of calcium carbonate, may be less than 250 μm.

A polymer comprising a calcium salt may comprise other compounds intended to improve the biocompatibility, biomimicry, printability, roughness and/or hardness of a device or of a support structure according to the invention.

For example, biomimicry is improved by adding calcium salts and dyes mimicking the color of corals to the printing polymer.

The roughness and/or hardness of a device or of a support structure according to the invention may be improved by adding particles of wood or stone to the printing polymer.

As additional compounds capable of modulating the hardness of a device or of a structure according to the invention, mention may be made, for example, of chitosan, chitin, starch, or alginates.

As additives which may be used with the polymers used in the invention, mention may also be made of dyes. The dyes may advantageously be used to obtain a biomimicry effect.

Many types of dyes may be used. Preferably, biocompatible or biosourced dyes are used. As examples of dyes which may be used in the invention, mention may be made of curcumin, bixin, anthocyanins, chlorophyll, astaxanthin, naphthoquinones, carotenoids, or dyes extracted from grapes, strawberries, apples, cherries or red cabbage.

The coloring of the polymers that may be used in a method of the invention may be achieved by incorporation of a masterbatch into the biopolymer during its production before extrusion into a filament for 3D printing.

A polymer suitable for the invention may be a lactic acid polymer comprising chitosan and hydroxyapatite as described in Nazeer et al. (Materials Today Communications, Vol. 25, 2020, 101515: 3D printed poly(lactic acid) scaffolds modified with chitosan and hydroxyapatite for bone repair applications, doi.org/10.1016/j.mtcomm.2020.101515).

A polymer suitable for the invention may be a lactic acid polymer comprising hydroxyapatite as described in Dubinenko et al. (Journal of Applied Polymer Science (2021; 138:e49662): Highly filled poly(l-lactic acid)/hydroxyapatite composite for 3D printing of personalized bone tissue engineering scaffolds. doi.org/10.1002/app.49662).

A polymer suitable for the invention may be a lactic acid polymer comprising calcium carbonate as described in Gayer et al. (Materials Science and Engineering: C, Vol. 101, 2019, pages 660-673: Development of a solvent-free polylactide/calcium carbonate composite for selective laser sintering of bone tissue engineering scaffolds; doi.org/10.1016/j.msec.2019.03.101.) or as described in Nunes et al. (International Journal of Innovative Science, Engineering & Technology, Vol. 4, Issue 6, June 2017: Evaluation of the Poly (Lactic Acid) and Calcium Carbonate Effects on the Mechanical and Morphological Properties in PBAT Blends and Composites).

A biodegradable polymer comprising at least one calcium salt suitable for the invention may be a lactic acid polymer comprising calcium carbonate. Advantageously, the calcium carbonate is introduced into the polymer in the form of ground of Ostreidae shell, such as for example ground of oyster shell.

As an example of a lactic acid polymer comprising calcium carbonate suitable for the invention, mention may also be made of the filament polymer Francofil 1.75 mm PLA filament: Co-product Oyster sold by the company Francofil under the reference FRF341674.

### Manufacturing Method

A device or a support structure according to the invention may be manufactured by any method known in the field, in particular one usable with polymers comprising a calcium salt, such as described above.

A manufacturing method suitable for the invention allows texturing of the surface of the device or of the support structure.

A method for manufacturing a device or a structure of the invention may be a three-dimensional printing (or 3D printing) method. A 3D printing method advantageously makes it possible to obtain surface texturing of the device or structure during the printing step.

Depending on the product to be manufactured, device or support structure, the printing method may include different parameters and printing modes.

3D printing methods are well known.

Prior to printing, a device or a structure according to the invention is modeled. Such a model may be developed using various software, for example Catia, Fusion360, Solidworks or Creo, and the final format is generated in machine readable format, for example STEP, STL or OBJ. The resulting model is then sliced into layers by slicing software. The dimensions of the layers (length, diameter) are adapted to the printing equipment used, in particular the extrusion nozzle, to the dimensions of the polymer filament, and also to the extrusion rates/second. The layers must be sufficiently thick and close to one another to ensure the solidity of the printed object, but also far enough apart and/or thin enough to give the printed object the desired flexibility. The software converts the model into coordinates that the 3D printer understands and the polymer is deposited in layers on top of one another according to these coordinates during the printing process. On output, the model is in the form of a text file with a “.gcode” file extension.

A device or structure according to the invention may be printed using various 3D printing technologies. 3D printing is an additive manufacturing technology wherein a 3D object is created by depositing layers of materials to create a physical object. Printers that work by extrusion and fused deposition (FDM) use polymer filaments, such as PLA (lactic acid polymer), ABS (acrylonitrile butadiene styrene), PC (polycarbonate), PET-G (glycolyzed polyethylene terephthalate), printers for 3D printing in stereolithography (SLA) or by DLP (Digital Light Processing) use resins, and SLS (Selective Laser Sintering) technology uses a powdered material, for example nylon.

In particular, a method for manufacturing a device or a support structure according to the invention may use technology by extrusion and fused deposition (“fused filament modeling” (FFM), “melted and extruded modeling” (MEM), “fused filament fabrication” (FFF), or “fused deposition method” (FDM)).

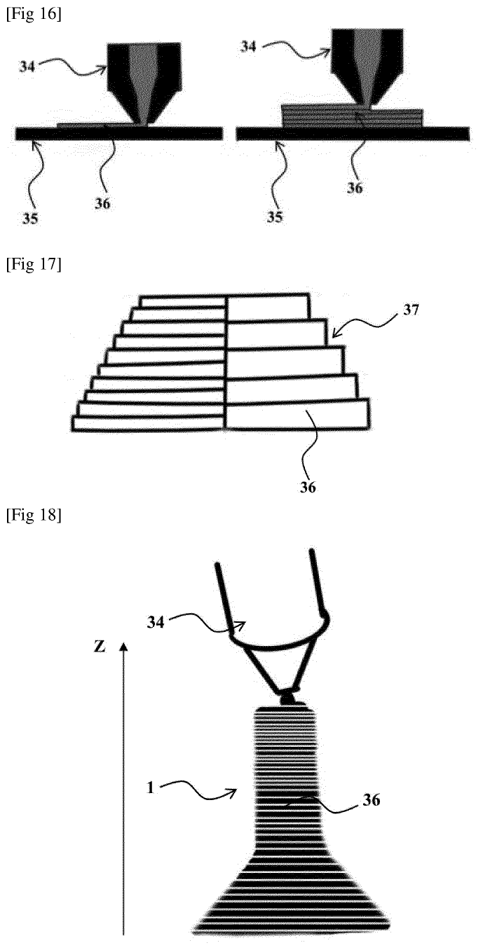

FIG. 16 schematically depicts fused deposition printing wherein a 3D printer nozzle (34) deposits a succession of layers (36) of molten polymer on a work surface (35).

As shown in FIG. 17, the layers (36) of molten polymer extruded and deposited by the 3D printer nozzle lead to the formation of striations (37) on the surface of the manufactured product. The greater the thickness of the layers of molten polymer deposited by the 3D printer nozzle, the deeper the striations will be, and the greater the average surface roughness value will be. The thinner the layers of molten polymer deposited by the 3D printer nozzle, the less deep the striations will be, and the smaller the average surface roughness value will be.

A method for 3D printing a device according to the invention may be performed in “vase” mode. This 3D printing mode means that the wall is printed in a single layer, without interruption of the extruder (or printing nozzle). The z axis rises gradually rather than layers being produced one by one as in standard printing. Such printing is advantageously performed without infill. The layer is gradually deposited on itself by rotating the printing nozzle about the longitudinal axis of the device. The stacking of the layer leads to the formation of striations forming the texturing of the surface.

FIG. 18 shows 3D printing of a “valve” type holding device of the invention using a method by deposition of layers of molten polymer. The 3D printing nozzle (34) continuously deposits, progressing along the Z axis, a stacked layer (36) of molten polymer to form the contour, without infill (vase mode), of a device of “valve” type (1).

A device according to the invention may be printed by 3D printing using fused deposition technology, with an extrusion nozzle having a diameter of around 0.4 mm. The printing speeds, layer thicknesses and extrusion temperatures will depend on the polymer used and the nozzle used. Usually, a layer thickness should not exceed 80% of the nozzle diameter.

For example, for a lactic acid polymer comprising calcium carbonate, such as that marketed by the company Francofil, under the reference FRF341674, the nozzle temperature may be around 200° C. (between 185° C. and 230° C.), the printing surface temperature around 30° C. (between 20° C. and 30° C.), the printing speed around 60 mm/s (between 40 and 100 mm/s), and the layer height from around 0.5 μm to around 320 μm.

A support structure according to the invention may be printed by 3D printing using fused deposition technology, with an extrusion nozzle with a diameter of around 1.2 mm. The printing speeds, layer thicknesses and extrusion temperatures will depend on the polymer used, the nozzle used, and the density and model of infill chosen.

A support structure according to the invention may be printed in 3D with a lactic acid polymer comprising calcium carbonate, such as that marketed by the company Francofil, under the reference FRF341674, with the specific features described above. The layer height may range from around 0.5 μm to around 770 μm.

Printing may be performed, for example, with a maximum layer thickness of around 3 mm. Such a layer thickness makes it possible to provide the object with good solidity and good water resistance while maintaining a striated appearance with the roughness necessary for the attachment of the corals.

The number of cells in the internal part of a support structure of the invention obtained by 3D printing, and their dimensions, depend in particular on the type of infill chosen and the density thereof. The density and model of infill are adjusted to obtain the best compromise in terms of solidity, weight and cost of the part produced and to ensure that the support structure fills with water when it is immersed. Various types of infill are available: in hexagonal, triangular, rectilinear, grid, wave, etc. cells.

A method for 3D printing of a support structure according to the invention may be performed with an infill (or filling) of honeycomb shape. The infill may have a density of between 1 and 50%.

The holes in a support structure according to the invention may be obtained either during printing or after printing, by drilling or boring, for example using a drill or a heated pin.

According to one variant embodiment, a method for manufacturing a device or a structure of the invention may be a method for extrusion blow molding of a polymer in a mold representing, in hollow format, the device or the structure of the invention to be reproduced. Alternatively, a manufacturing method may be an injection molding method. In such methods, the walls of the mold may have, recessed, the texturing patterns to be printed on the surface of the device or structure.

In the case of a structure according to the invention, the method may include a step of drilling, by any suitable method, such as a drill or heated pin, holes intended to subsequently receive the holding devices according to the invention.

According to yet another alternative, a mold used to manufacture a device according to the invention may have no texturing patterns to be printed on the surface, and the texturing may be added subsequently by a step of engraving.

The invention is not limited to the examples which have just been described; in particular, features of the examples illustrated may be combined with one another in variants not illustrated. Other variants and improvements may be considered without thereby departing from the scope of the invention.

### LIST OF REFERENCES CITED

Dubinenko Gleb, Zinoviev Aleksey, Bolbasov Evgeny, Kozelskaya Anna, Shesterikov Evgeniy, Novikov Victor, Tverdokhlebov Sergei, Journal of Applied Polymer Science, 2021; 138:e49662): Highly filled poly(l-lactic acid)/hydroxyapatite composite for 3D printing of personalized bone tissue engineering scaffolds. doi.org/10.1002/app.49662
Gayer Christoph, Ritter Jessica, Bullemer Martin, Grom Stefanie, Jauer Lucas, Meiners Wilhelm, Pfister Andreas, Reinauer Frank, Vučak Marijan, Wissenbach Konrad, Fischer Horst, Pop Reinhart, Materials Science and Engineering: C, Vol. 101, 2019, pages 660-673: Development of a solvent-free polylactide/calcium carbonate composite for selective laser sintering of bone tissue engineering scaffolds; doi.org/10.1016/j.msec.2019.03.101
Nazeer Muhammad Anwaar, Onder Ozgun Can, Sevgili Ilkem, Yilgor Emel, Kavakli Ibrahim Halil, Yilgor Iskender, Materials Today Communications, Vol. 25, 2020, 101515: 3D printed poly(lactic acid) scaffolds modified with chitosan and hydroxyapatite for bone repair applications; doi.org/10.1016/j.mtcomm.2020.101515
Nunes Edilene de C. D., de Souza Alana G., Coiado Renata D. S., Moura Esperidiana A. B. and Rosa Derval dos S., International Journal of Innovative Science, Engineering & Technology, Vol. 4, Issue 6, June 2017: Evaluation of the Poly (Lactic Acid) and Calcium Carbonate Effects on the Mechanical and Morphological Properties in PBAT Blends and Composites

1. A device for holding a coral cutting, said device comprising:
a first hollow tubular element extending along a longitudinal axis and comprising a distal end, a proximal end, an inner face and an outer face, and
a second element arranged co-axially to the proximal end of the first element and comprising a flared part defining a flat surface comprising a plane diverging circumferentially around the longitudinal axis of the first element,
wherein said device has a textured surface on said inner face.

2. The device as claimed in claim 1, wherein said flared part comprises an edge defining, with the flat surface, a flange around said longitudinal axis, said flange being deformable in a direction substantially parallel to the longitudinal axis of said tubular member.

3. The device as claimed in claim 1, wherein the flared part of the second element comprises at least four elongate protrusions, each protrusion comprising a distal end, said protrusions being arranged in the plane of the surface of the flared part and extending, with said flared part, in an arc of a circle, in a direction of the longitudinal axis of the hollow tubular element, in such a way as to form, with all of the distal ends positioned around said longitudinal axis, a holding member.

4. The device as claimed in claim 1, wherein the first element comprises at least one spike extending from the inner face toward the inside of said element.

5. The device as claimed in claim 1, said device being formed of a material comprising at least one biodegradable polymer and at least one calcium salt.

6. A support structure for at least one device as claimed in claim 1, comprising a continuous surface comprising at least one hole configured to receive a hollow tubular element of the device, said surface being textured.

7. The support structure as claimed in claim 6, said structure comprising an internal part made up of a plurality of cells in communication with one another and, directly or indirectly, with the holes.

8. A combination of the support structure as claimed in claim 6 together with the at least one device.

9. The combination as claimed in claim 8 wherein the at least one device has a flared part which comprises an edge defining, with the flat surface, a flange around said longitudinal axis, said flange being deformable in a direction substantially parallel to the longitudinal axis of said tubular member, and wherein said at least one device is, arranged in a hole in the structure, wherein said flange of said at least one device is affixed to the surface of said structure.

10. A method for manufacturing a device for holding a coral cutting as claimed in claim 1, comprising at least one step consisting in 3D printing said device.

11. A method for manufacturing a device for holding a coral cutting as claimed in claim 1, the method comprising at least a step of 3D printing said device with a biodegradable polymer comprising at least one calcium salt.

12. A method for manufacturing a support structure (27) as claimed in claim 7, comprising at least one step consisting in 3D printing said support structure.

13. A method for manufacturing support structure as claimed in claim 7, the method comprising at least a step of 3D printing said device with a biodegradable polymer comprising at least one calcium salt.
